(19) United States
(12) Patent Application Publication
(10) Pub. No.: US 2025/0358621 A1
(43) Pub. Date: Nov. 20, 2025

(54) APPARATUS AND METHODS FOR AUTOMATIC APPLICATION DISABLEMENT

(71) Applicant: Diana Flores, Miami, FL (US)

(72) Inventor: Diana Flores, Miami, FL (US)

(21) Appl. No.: 18/664,018

(22) Filed: May 14, 2024

(51) Int. Cl. H04W 12/63; G06F 8/61; H04W 12/06

(52) U.S. Cl. CPC H04W 12/63; G06F 8/62; H04W 12/068

(57) ABSTRACT

This application relates to apparatus and methods for automatically detecting, and limiting, unsafe mobile device use. In some examples, a computing device stores instructions for a safety application. The computing device executes the instructions to, among other things, receive location data characterizing a location of the computing device. Based on the location data, the computing device generates speed data characterizing a speed of the computing device. Based on the speed data, the computing device disables a plurality of applications that are otherwise executable by the computing device. Further, the computing device detects a request to delete the safety application. Based on the detected request, the computing device generates a request for credential data. The request may be a user interface that allows for inputting of the credential data. Based on credential data received in response to the request, the computing device determines whether to delete the safety application.

### FIELD OF THE INVENTION

The disclosure relates generally to networked safety systems and, more specifically, to networked mobile devices that execute safety applications and related computing systems.

### BACKGROUND

Networked mobile devices, such as cellular phones, smart phones, tablets, smart watches, and similar devices, can allow users to interact with applications. For example, users can access social media through one or more various applications that execute on mobile devices. As another example, users can use a texting application to text other users. Unfortunately, these activities can distract users from other tasks, such as more important, urgent, or higher priority tasks. For instance, a user may attempt to engage a mobile application while driving a vehicle. By engaging with the mobile application, the user can be distracted from their driving responsibilities.

### SUMMARY

In some examples, a computing device includes a memory storing instructions for a safety application, and at least one processor communicatively coupled to the memory. The at least one processor is configured to execute the instructions to receive location data characterizing a location of the computing device. The at least one processor is also configured to execute the instructions to, based on the location data, generate speed data characterizing a speed of the computing device. Based on the speed data, the at least one processor is configured to execute the instructions to disable at least one executable application of the computing device. The at least one processor is also configured to execute the instructions to detect a request to delete the safety application. Based on the detected request, the at least one processor is configured to execute the instructions to generate a request for credential data.

In some examples, a method by at least one processor for executing a safety application includes receiving location data characterizing a location of a computing device. The method also includes, based on the location data, generating speed data characterizing a speed of the computing device. Based on the speed data, the method includes disabling at least one executable application of the computing device. The method also includes detecting a request to delete the safety application. Based on the detected request, the method includes generating a request for credential data.

In some examples, a non-transitory computer readable medium has instructions stored thereon for a safety application, wherein the instructions, when executed by at least one processor, cause a device to perform operations. The operations include receiving location data characterizing a location of a computing device. The operations also include, based on the location data, generating speed data characterizing a speed of the computing device. Based on the speed data, the operations include disabling at least one executable application of the computing device. The operations also include detecting a request to delete the safety application. Based on the detected request, the operations include generating a request for credential data.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a mobile device safety system, in accordance with some embodiments;

FIG. 2 is a block diagram of a mobile device with a safety application, in accordance with some embodiments;

FIG. 3 is a block diagram of a mobile device with safety functionality, in accordance with some embodiments;

FIG. 4 illustrates a messaging diagram, in accordance with some embodiments;

FIG. 5A illustrates a user interface that is displayed in response to a detected violation, in accordance with some embodiments;

FIG. 5B illustrates alert graphical elements that may be displayed within the user interface of FIG. 5A, in accordance with some embodiments;

FIG. 5C illustrates a display of icons, in accordance with some embodiments;

FIG. 5D illustrates a display of icons, in accordance with some embodiments;

FIG. 6 is a flowchart of an example method to disable mobile applications, in accordance with some embodiments; and

FIG. 7 is a flowchart of an example method to delete a safety application, in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

This application relates to apparatus and methods for automatically detecting, and limiting, unsafe mobile device use. For instance, as described herein, in some examples a computing device stores instructions for a safety application. The computing device executes the instructions to, among other things, receive location data characterizing a location of the computing device. Based on the location data, the computing device generates speed data characterizing a speed of the computing device. Based on the speed data, the computing device determines whether to disable a plurality of applications that are otherwise executable by the computing device. Further, the computing device detects a request to delete the safety application. Based on the detected request, the computing device generates a request for credential data. The request may be a user interface that allows for inputting of the credential data. Based on credential data received in response to the request, the computing device determines whether to delete the safety application.

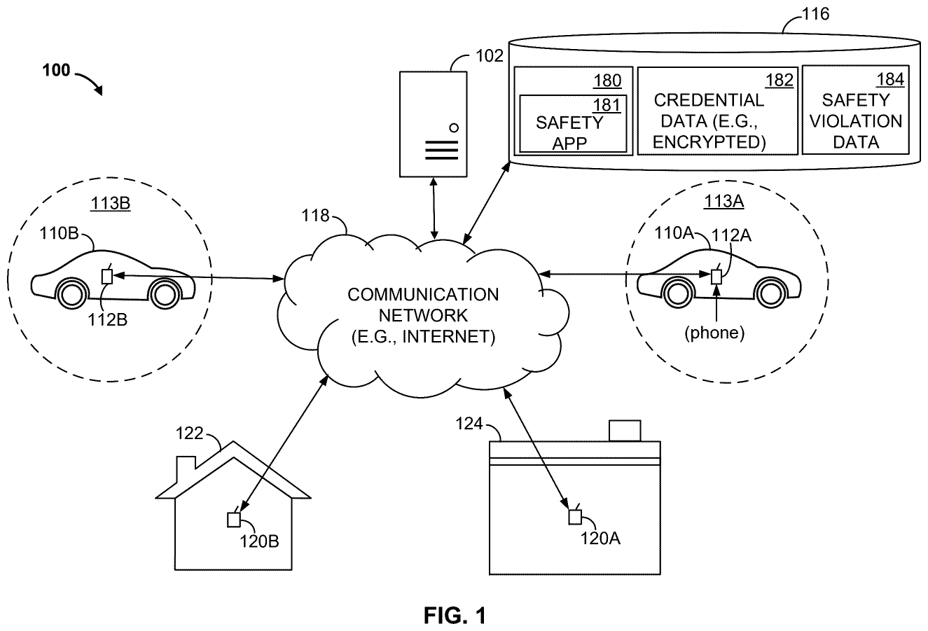

Turning to the drawings, FIG. 1 illustrates a block diagram of a mobile device safety system 100 that includes a safety computing device 102, user devices 112A, 112B, guardian devices 120A, 120B, and a database 116 communicatively coupled over a communication network 118. Safety computing device 102, user devices 112A, 112B, and guardian devices 120A, 120B can each be any suitable computing device that includes any hardware or hardware and software combination for processing and handling information. For example, each of safety computing device 102, user devices 112A, 112B, and guardian devices 120A, 120B can include one or more processors, one or more field-programmable gate arrays (FPGAs), one or more application-specific integrated circuits (ASICs), one or more state machines, digital circuitry, or any other suitable circuitry.

In some embodiments, safety computing device 102 can be a computer, a workstation, a laptop, a tablet, a server such as a cloud-based server or an application server, or any other suitable computing device. Each of the user devices 112A, 112B and guardian devices 120A, 120B can be a mobile device such as a cellular phone or smart phone, a tablet, a personal assistant device, a voice assistant device, or a digital assistant device. Each of the user devices 120A, 120B and guardian devices 120A, 120B can also be a mobile device a more stationery computing device, such as a computer, a workstation, or a laptop. In addition, addition, each of the safety computing device 102, user devices 112A, 112B, and guardian devices 120A, 120B can transmit data to, and receive data from, communication network 118.

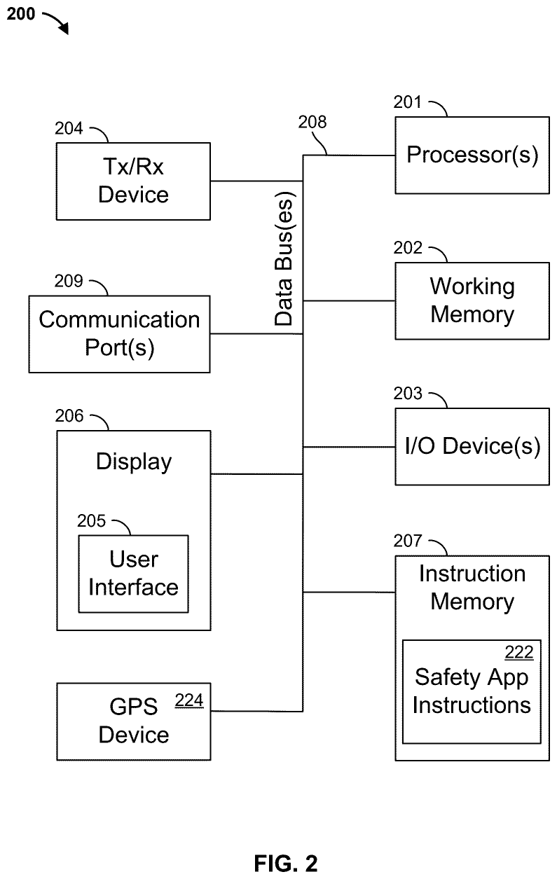

FIG. 2 illustrates an example of a user device 200, in accordance with some examples. User device 200 may be one of the user devices 112A, 112B of FIG. 1, for example. As illustrated, user device 200 includes one or more processors 201, working memory 202, one or more input/output (I/O) devices 203, instruction memory 207, a transceiver 204, one or more communication ports 209, a display 206, and a Global Positioning System (GPS) device 224, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory, an electrically erasable programmable read-only memory (EEPROM), flash memory, a removable disk, CD-ROM, any non-volatile memory, or any other suitable memory. In this example, instruction memory 207 includes safety application instructions 222 that can be executed by the one or more processors 201 to establish and execute any of the safety application functions described herein.

Further, processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of component model computing device 102. Working memory 202 can be a random access memory (RAM) such as a static random access memory (SRAM) or dynamic random access memory (DRAM), or any other suitable memory.

I/O devices 203 can include any suitable device that allows for data input and/or output. For example, I/O devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allows for the charging of batteries, such as batteries to power computing device 200.

Display 206 can display user interface 205. User interfaces 205 can enable user interaction with user device 200. For example, user interface 205 can be a user interface for the safety application established when processor 201 executes the safety application instructions 222 stored in instruction memory 207. In some examples, display 206 can be a touchscreen, where user interface 205 is displayed on the touchscreen.

Transceiver 204 allows for communication with a network, such as communication network 118 of FIG. 1. For example, if communication network 118 is a cellular network, transceiver 204 is configured to allow communications with the cellular network. Processor(s) 201 is operable to receive data from, or send data to, a network, such as communication network 118, via transceiver 204.

Referring back to FIG. 1, database 116 includes an application store 180 (i.e., “App” store) from which computing devices, such as user devices 112A, 112B and guardian devices 120A, 120B, can download a safety application 181. For instance, each of user devices 112A, 112B can request, from safety computing device 102, to download the safety application from the App store 180. The user devices 112A, 112B may parse the safety application 181 to extract executable instructions, and store the executable instructions as the safety application instructions 222 described herein.

As described herein, the safety application 181, when installed and executed by user devices 112A, 112B, can only be deleted (e.g., disabled, removed) when valid credential data is received. Further, while installed, the executed safety application can detect one or more safety violations, such as a speeding violation. When a safety violation is detected, the executed safety application prevents access to other applications on the respective user device 112A, 112B. For example, the executed safety application may prevent access to social media applications, texting applications, and marketplace applications, among other examples. In some examples, and upon detecting a safety violation, the executed safety application prevents access to all applications on the user device 112A, 112B. In some instances, the executed safety application also prevents outgoing and/or incoming calls. The executed safety application may restore access to the applications and/or outgoing and/or incoming calls upon detecting that the safety violation has ended.

For instance, a guardian (e.g., parent) of a user of user device 112A, 112B may download, or may have the user download, the safety application from the App store 180 onto user device 112A, 112B. When the safety application is executed, the safety application may cause the user device 112A, 112B to display, within a user interface, various setup questions with input response fields (e.g., during a “setup” process). For example, the executed safety application may cause the display of a user interface with one or more input fields for guardian contact information (e.g., guardian cellphone number, IP address, username and password, etc.) and, in some examples, user contact information (e.g., contact information for a user of user device 112A, 112B). Based on the guardian contact information, the safety application installed on the user device 112A, 112B may be associated with a corresponding guardian application installed on a guardian's guardian device 120A, 120B (e.g., downloaded from App store 180).

Further, the executed safety application may provide input field(s) for credential data 182, such as a password. The credential data 182 allows, among other things, for the deletion of the safety application from the user device 112A, 112B. In other words, once installed, in some examples the safety application can only be deleted (e.g., removed, disabled) by inputting matching credential data 182. As such, the guardian, but not the user, would in at least some examples provide the credential data 182, and keep the credential data 182 as secret. The user device 112A, 112B may store the credential data 182 within, for example, a non-volatile memory device (e.g., instruction memory 207). In some examples, the user device 112A, 112B may encrypt the credential data 182, and may securely store the credential data 182 locally within the non-volatile memory, and/or may store the credential data 182 within database 116.

Further, the executed safety application may allow for entry of violation information to enable one or more safety violation detections. For example, the executed safety application may allow for entry of a speed threshold characterizing a maximum speed (e.g., 5 miles-per-hour (mph), 7 mph, 15 mph, 25 mph, 40 mph 55 mph, 65 mph), and/or area data (e.g., zip code, geofence, town, area within a particular radius of a particular address, etc.) characterizing a geographical area for the user device 112A, 112B. For example, and as described herein, the executed safety application may disallow access to other applications and or outgoing or incoming calls when the user device 112A, 112B is detected to be travelling faster than the provided speed threshold. Similarly, the executed safety application may disallow access to other applications and or outgoing or incoming calls when the user device 112A, 112B is detected to be outside of the geographical area characterized by the area data. The user device 112A, 112B may generate safety violation data 184 based on the inputted violation information, and may store the safety violation data 184 within a non-volatile memory and/or within database 116. In some examples, the user device 112A, 112B encrypts the safety violation data 184, and securely stores the safety violation data 184 within a non-volatile memory, and/or within database 116.

For example, as illustrated in FIG. 1, user device 112A may be travelling a vehicle 110A within a geographical area 113A. Once installed, the executed safety application may receive location data, such as GPS data (e.g., via GPS device 224) or cell tower data (e.g., via transceiver 204 using triangulation techniques), over a period of time. Based on the location data received, the executed safety application determines a speed of the vehicle 110A (e.g., a real-time speed, an average speed). The executed safety application may compare the determined speed with the original inputted speed threshold. If the determined speed is greater than the originally inputted speed, the executed safety application disables access to the one or more other applications as described herein. This may prevent the user of the user device 112A from being distracted by the disallowed applications. Similarly, the executed safety application may disable outgoing calls, further preventing the user of the user device 112A from being distracted while driving. In some instances, the executed safety application allows calls to and from one or more predetermined numbers, such as the phone number of a guardian or parent (e.g., of guardian device 120A), which can also be configured during the setup process.

In some examples, the executed safety application may detect that the vehicle 110A is outside of the area 113A and, in response, may disable access to the one or more other applications and or disable outgoing or incoming calls. In some examples, the executed safety application disables access to the one or more other applications and or disable outgoing or incoming calls when the speed threshold is exceeded and the vehicle 110A is outside of the area 113A. In some instances, the executed safety application allows calls to and from one or more predetermined numbers, such as the phone number of a guardian or parent (e.g., of guardian device 120A).

In some instances, when the executed safety application detects a safety violation, the executed safety application causes the user device 112A to transmit an alert to the guardian device 120A, which may be located, for instance, in an office building 124. A user of the guardian device 120A may be the guardian of the user of the user device 112A. The alert may identify the safety violation detected. For example, if a speed violation is detected, the user device 112A may generate speed alert data characterizing the speed violation, and may transmit the speed alert data to the guardian device 120A. In some examples, the speed alert data may identify the speed at which the user device 112A was travelling. In some examples, the user device 112A encrypts the speed alert data based on a public key, and the receiving guardian device 120A decrypts the speed alert data based on a corresponding private key. Similarly, if the executed safety application detects that the user device 112A is outside of the area 113A, the user device 112A may generate area alert data identifying the area violation, and may transmit the area alert data to the guardian device 120A. In some examples, the area alert data may identify a last known location of the user device 112A. In some examples, the user device 112A encrypts the area alert data based on a public key, and the receiving guardian device 120A decrypts the speed alert data based on a corresponding private key.

Similarly, user device 112B may be travelling a vehicle 110B within a geographical area 113B. Based on location data received for user device 112B (e.g., via GPS, cell tower triangulation), the executed safety application determines a speed of the vehicle 110B. The executed safety application may compare the determined speed with the originally inputted speed threshold. If the determined speed is greater than the originally inputted speed, the executed safety application disables access to the one or more other applications as described herein. This may prevent the user of the user device 113B from being distracted by the disallowed applications. Similarly, the executed safety application may disable outgoing calls, further preventing the user of the user device 113B from being distracted while driving. In some instances, the executed safety application allows calls to and from one or more predetermined numbers, such as the phone number of a guardian or parent (e.g., of guardian device 120B), which can also be configured during the setup process.

In some examples, the executed safety application may detect that the vehicle 110B is outside of the area 113B and, in response, may disable access to the one or more other applications and or disable outgoing or incoming calls. In some examples, the executed safety application disable access to the one or more other applications and or disable outgoing or incoming calls when the speed threshold is exceeded and the vehicle 110B is outside of the area 113B. In some instances, the executed safety application allows calls to and from one or more predetermined numbers, such as the phone number of a guardian or parent (e.g., of guardian device 120B).

In some instances, when the executed safety application detects a safety violation, the executed safety application causes the user device 112B to transmit an alert to the guardian device 120B, which may be located in a house 122. A user of the guardian device 120B may be the guardian of the user of the user device 112B. The alert may identify the safety violation detected. For example, if a speed violation is detected, the user device 112B may generate speed alert data characterizing the speed violation, and may transmit the speed alert data to the guardian device 120B. The speed alert data may identify the speed at which the user device 112B was travelling. In some examples, the user device 112B encrypts the speed alert data based on a public key, and the receiving guardian device 120B decrypts the speed alert data based on a corresponding private key. Similarly, if the executed safety application detects that the user device 112B is outside of the area 113B, the user device 112B may generate area alert data indicating that the user device 112B is outside of the area 113B, and may transmit the area alert data to the guardian device 120B. In some examples, the area alert data may identify a last known location of the user device 112B (e.g., based on GPS data). In some examples, the user device 112B encrypts the area alert data based on a public key, and the receiving guardian device 120B decrypts the area alert data based on a corresponding private key.

To remove (e.g., delete) the safety application 181 from the user device 112A, 112B, in at least some examples, credential data matching at least portions of the credential data 182 previously inputted (e.g., by a guardian of the user of user device 112A, 112B) must be received. For example, upon installing and executing the safety application 181, the executed safety application can detect a request for deletion. The executed safety application will “block” the request and, in some examples, generate and provide for display a user interface that includes at least one input field for credential data. The user of user device 112A, 112B may input (e.g., type in) credential data into the input field (e.g., via I/O device 203, touchscreen, etc.). The executed safety application receives the inputted credential data, and compares the inputted credential data to the originally stored credential data 182. In some instances, the executed safety application retrieves the originally stored credential data 182 from database 116. If the inputted credential data matches (e.g., is the same as) the originally stored credential data 182, the executed safety application allows the deletion request.

For instance, the user device 112A, 112B may disable (e.g., uninstall, delete) the safety application (e.g., deletes from internal memory storing the instructions for the safety application 181). If, however, the inputted credential data does not match the originally stored credential data 182, the deletion request is not allowed. In some examples, the executed safety application may display an error message indicating that the inputted credential data is not valid.

In some examples, when the user of user device 112A, 112B inputs the credential data into the input field, the executed safety application causes the user device 112A, 112B to transmit a credential request to the guardian device 120A, 120B of the user's guardian (e.g., as inputted during the setup process). The credential request causes the receiving guardian device 120A, 120B to display a message with an input field for the credential data. Based on receiving inputted credential data, the guardian device 120A, 120B transmits the credential data to the user device 112A, 112B. The user device 112A, 112B may then compare the received credential data to the originally stored credential data 182 to determine whether the deletion request is allowed, as described herein.

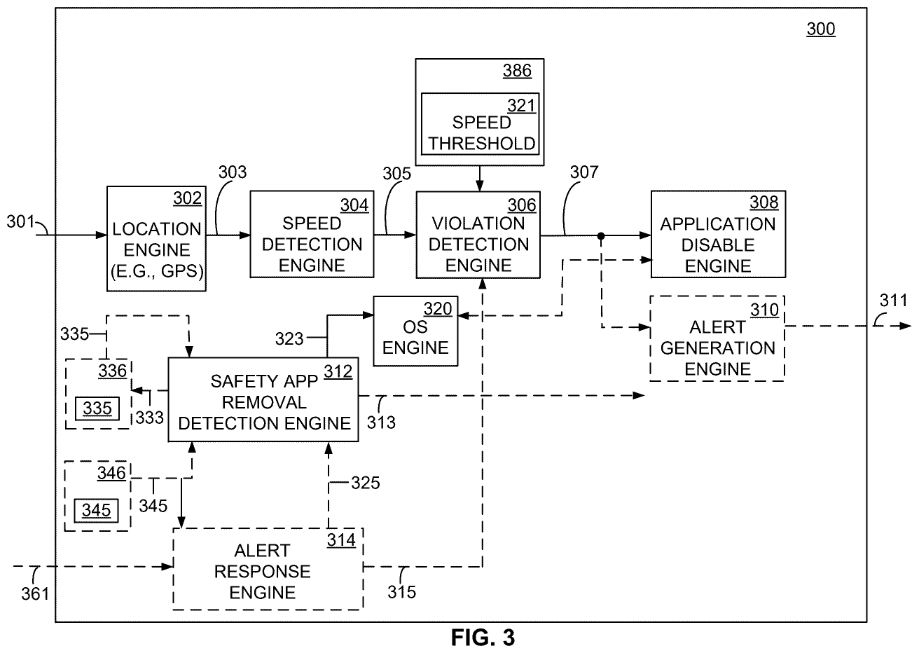

FIG. 3 illustrates an example of a user device 300, which may be, for instances, any of the user devices 112A, 112B of FIG. 1. As illustrated, user device 300 includes a location engine 30, a speed detection engine 304, a violation detection engine 306, an application disable engine 308, a safety application removal detection engine 312, and an operating system (OS) engine 320. User device may also include an alert generation engine 310 and an alert response engine 314. Each of the location engine 30, speed detection engine 304, violation detection engine 306, application disable engine 308, safety application removal detection engine 312, OS engine 320, alert generation engine 310 and alert response engine 314 may be implemented in within hardware, such as within digital circuitry, one or more FPGAs, one or more ASICs, or any other suitable logic. In some examples, one or more of the functions of any of the location engine 30, speed detection engine 304, violation detection engine 306, application disable engine 308, safety application removal detection engine 312, OS engine 320, alert generation engine 310 and alert response engine 314 can be implemented in software as executable instructions such that, when executed by one or more processors, cause the one or more processors to perform respective functions as described herein. The instructions can be stored in a non-transitory, computer-readable storage medium, and can be read and executed by the one or more processors. For instance, in some examples, one or more portions of any of location engine 30, speed detection engine 304, violation detection engine 306, application disable engine 308, safety application removal detection engine 312, OS engine 320, alert generation engine 310 and alert response engine 314 can be implemented by one or more processors 201 executing instructions stored within instruction memory 207 (e.g., safety application instructions 222).

In this example, location engine 302 receives location data 301. Location engine 302 may be a GPS device, for example, and location data 301 may be GPS data (e.g., GPX, or GPS Exchange Formatted data) or, for instance, cell tower and/or Wi-Fi triangulation data. Location engine 302 may process and format the location data 301 to determine a location of the user device 300, and transmit formatted location data 303 to speed detection engine 304. In some examples, the formatted location data 303 includes a location and a corresponding time (e.g., time of location data 301 reception). Speed detection engine 304 may receive formatted location data 303 over a temporal period. For instance, speed detection engine 304 may receive first formatted location data 303 associated with a first time, and second formatted location data 303 associated with a second time, where the second time is later than the first time. In some instances, the formatted location data 303 includes a time offset, indicating an amount of time since the last formatted location data 303 was transmitted.

Based on the formatted location data 303, speed detection engine 304 determines a speed of the user device 300. For instance, speed detection engine 304 may determine the speed by determining a distance between locations identified by the formatted location data 303, and dividing by a time difference associated with the locations. Speed detection engine 304 may execute any suitable algorithm to calculate the speed. In some examples, speed detection engine 304 determines the speed in real-time as formatted location data 303 is received. In some examples, speed detection engine 304 determines an average speed over an interval of time (e.g., 10 seconds, 30 seconds, a minute). Speed detection engine 304 generates speed data 305 characterizing the determined speed, and transmits the speed data 305 to the violation detection engine 306.

Violation detection engine 306 can determine whether a speed violation has occurred based on the speed data 305. For example, violation detection engine 306 may compare the speed data 305 to a speed threshold 321 which, as described herein, may have been provided during a setup process. For example, the violation detection engine 306 may read the speed threshold 321 from a non-volatile memory 386, and may compare the speed data 305 to the speed threshold 321. If the speed data 305 indicates a speed that is less than the speed threshold 321, no speed violation is detected. If, however, the speed data 305 indicates a speed that is the same or more than the speed threshold 321, the violation detection engine 306 generates an application disable signal 307, and transmits the application disable signal 307 to the application disable engine 308. Upon receiving the application disable signal 307, the application disable engine 308 may disable one or more applications from being accessed and/or executing. In some examples, the application disable engine 308 disables access to and/or execution of all social media applications and messaging applications. In some examples, the application disable engine 308 disables access to and/or execution of applications selected during the setup process of the safety application as described herein. In some examples, the application disable engine 308 disables access to and/or execution of all applications, such as to all messaging and texting capable applications. Additionally or alternatively, the application disable engine 308 may disable access (e.g., disable access to a phone application) to accept incoming calls, and/or to place outgoing calls. In some examples, the application disable engine 308 may disable the ability to place any calls other than to a predetermined phone number, such as the phone number of a guardian (e.g., the phone number of guardian device 120A, 120B).

In some instances, the application disable engine 308 transmits a disable signal indicating disabled applications, or a request to disable applications, to the OS engine 320. The OS engine 320 may execute an operating system and, based on receiving the disable signal, may configure the operating system to prevent opening of any of the disabled applications. In some examples, the OS engine 320 transmits a complete signal to the application disable engine 308 indicating that the applications have successfully, or unsuccessfully, been disabled and/or locked.

In some examples, alert generation engine 310 receives the application disable signal 307, and transmits an alert 311 to a user device (e.g., guardian device 120A, 120B) of a guardian of the user of the user device 300. For example, and as described herein, during a setup process of the safety application, the safety application installed on the user device 300 may be associated with a guardian application installed on a guardian's user device. The alert 311 may cause the guardian's user device to generate and display a user interface identifying the alert (e.g., user device 300 detected to be travelling at a speed above the speed threshold).

In some examples, the user of the user device 300 may place a call to the guardian's user device (e.g., guardian device 120A) when applications have been disabled (e.g., as the one phone number that is allowed to be called). The guardian may answer the call, and the user may explain, for instance, that they are on a train that is travelling over the speed threshold. In response, the guardian may provide credential data (e.g., a password) to a field of the displayed user interface, causing the guardian's user device to generate and transmit alert response data 361 that includes the credential data. The alert response engine 314 may receive the alert response data 361, and extract from the alert response data 361 the inputted credential data. The alert response engine 314 may further compare the received credential data to credential data 345 stored in non-volatile memory 346 (e.g., which may have been stored during the setup process of the safety application and may corresponding to credential data inputted by a guardian of user device 300). If the received credential data matches the credential data 345, the alert response engine 314 generates and transmits to the violation detection engine 306 violation satisfied data 315. Upon receiving the violation satisfied data 315, the violation detection engine 306 releases the application disable signal 307, thereby allowing all disabled applications to be accessed and/or executed.

In some instances, a user of user device 300 may attempt to delete the safety application (e.g., safety application 181). For instance, the user may attempt to perform an “uninstall” of the safety application. The safety application removal detection engine 312 detects the attempt, and prevents the user device 300 from deleting the safety application. In some instances, the safety application removal detection engine 312 transmits a lock request signal 323 to the OS engine 320. In response, the OS engine 320 locks the safety application, causing the operating system to ignore, block, and/or deny any request to disable (e.g., uninstall, delete) the safety application.

In some examples, when a deletion attempt is detected, the safety application removal detection engine 312 provides to display 336 user interface data 333 that includes an input field for the user to enter credential data. Based on the displayed user interface, the user may input credential data 335 into the input field, and the safety application removal detection engine 312 may receive the inputted credential data 335 from the display 336. The safety application removal detection engine 312 may compare the inputted credential data 335 to credential data 345 stored in non-volatile memory 346 (e.g., which may have been stored during the setup process of the safety application and may corresponding to credential data inputted by a guardian of user device 300). If the inputted credential data 335 matches the credential data 345, the safety application removal detection engine 312 removes restrictions disallowing the removal of the safety application.

In some examples, and based on determining that the inputted credential data 335 matches the credential data 345, the safety application removal detection engine 312 removes (e.g., uninstalls) the safety application from the user device 300. In some examples, and based on determining that the inputted credential data 335 matches the credential data 345, the safety application removal detection engine 312 releases the lock request signal 323 to the OS engine 320. As such, any request to the operating system to delete the safety application will be allowed.

In some examples, based on detecting an attempt to delete the safety application, safety application removal detection engine 312 generates a delete safety application request 313, and transmits the delete safety application request 313 to alert generation engine 310. The alert generation engine 310 may transmit an alert 311 identifying the request to delete the safety application to, for example, the guardian's user device (e.g., guardian device 120A).

In response to receiving the alert 311, the guardian may provide credential data (e.g., a password) to a field of a displayed user interface, causing the guardian's user device to generate and transmit alert response data 361 that includes the credential data. The alert response engine 314 may receive the alert response data 361, and extract from the alert response data 361 the inputted credential data 325. The alert response engine 314 may transmit the inputted credential data 325 to the safety application removal detection engine 312 and, based on the received credential data 325, the safety application removal detection engine 312 determine whether to allow the safety application to be deleted, as described herein. For example, the safety application removal detection engine 312 may compare the received credential data 325 to the credential data 345 stored in the non-volatile memory 346. If the received credential data 325 matches the credential data 345, the safety application removal detection engine 312 removes restrictions disallowing the removal of the safety application. Otherwise, the restrictions remain in place.

In some examples, and based on determining that the received credential data 325 matches the credential data 345, the safety application removal detection engine 312 removes (e.g., uninstalls) the safety application from the user device 300. In some examples, and based on determining that the received credential data 325 matches the credential data 345, the safety application removal detection engine 312 releases the lock request signal 323 to the OS engine 320. As such, any request to the operating system to delete the safety application will be allowed.

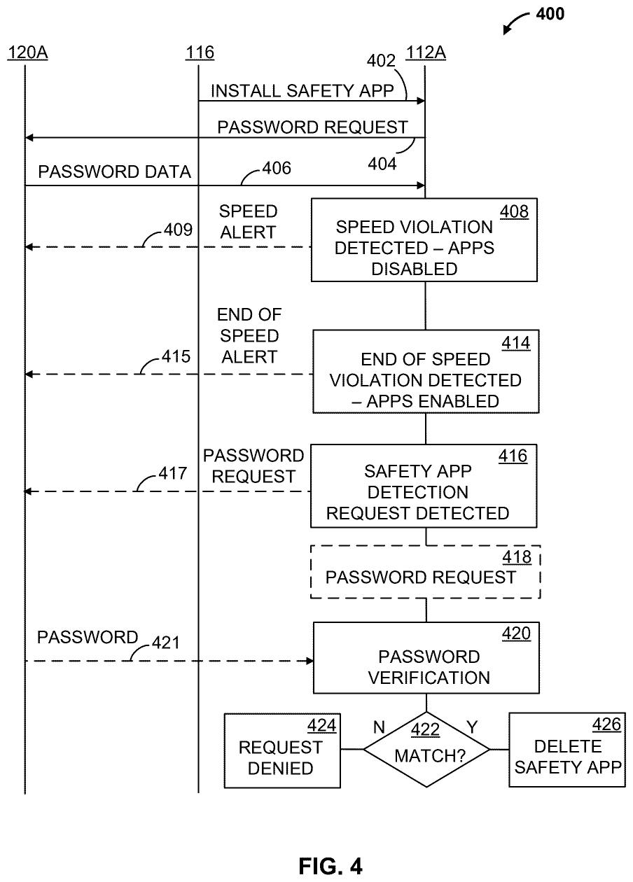

FIG. 4 illustrates a messaging scheme 400 between devices. For example, user device 112A may download 402 the safety application (e.g., safety application 181) from the database 116. During a setup process 404, the executed safety application transmits a password request to guardian device 120A. The guardian device 120A may have been identified by the user during the setup process, as described herein (e.g., by entering in a phone number of the guardian device 120A). In response, the user device 112A receives password data 406 characterizing an inputted password. The user device 112A now executes the installed safety application.

Further, at block 408, a speed violation is detected. For example, the executes safety application may detect that the user device 112A is traveling at a speed that is greater than a speed threshold provided during the setup process. The speed threshold may be, for example, 5 mph, 7 mph, 15 mph, 25 mph, 40 mph 55 mph, 65 mph, or any other suitable speed. In some examples, the user device 112A transmits a speed alert 409 to the guardian device 120A. The speed alert may cause the guardian device 120A to display an alert message identifying the speed violation.

At block 414, the executed safety application detects that the speed of the user device 112A is below the speed threshold, and re-enables the disabled applications. In some instances, the user device 112A transmits an end of speed alert 415 to the guardian device 120A indicating the end of the speeding violation.

Further, at block 416, the executed safety application detects an attempt to delete the safety application. In some examples, at block 418, the user device 112A displays a user interface with an input field for a password. In other examples, the user device 112A transmits a password request 417 to the guardian device 120A, and receives, in response, a password 421. In either case, at block 420, the received password is verified. For example, at block 422, the received password may be compared to the password received in the password request 404. If the passwords do not match, at block 424 the safety application deletion request is denied. If, however, the passwords do match, at block 426 the safety application is deleted from the user device 112A.

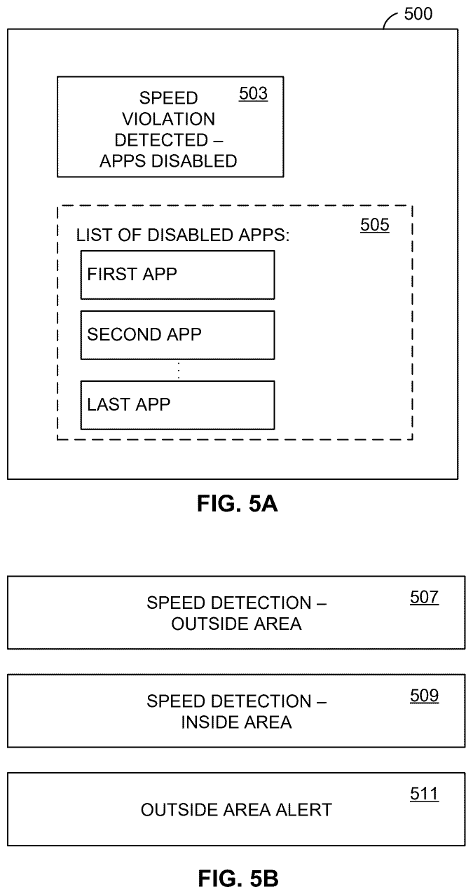

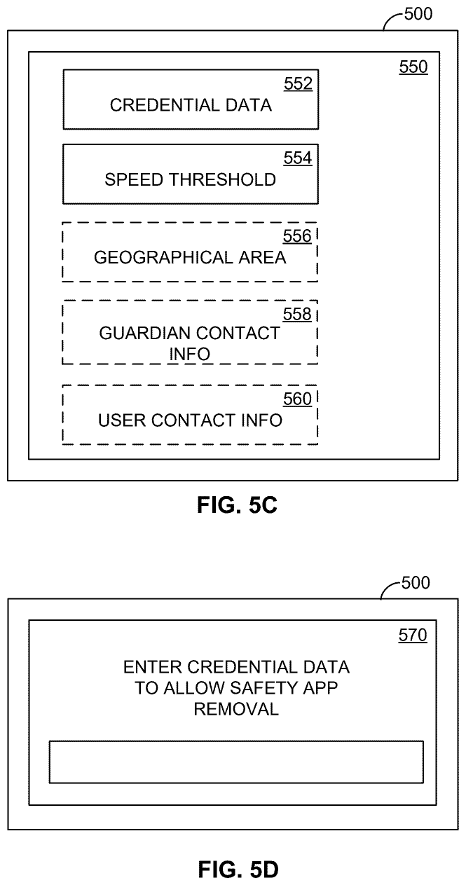

FIG. 5A illustrates a display 500, such as a display of any of user devices 112A, 112B, and/or guardian devices 120A, 120B. For example, a user device 112A, 112B may detect a speed violation as described herein, and in response may display a graphical user interface, such as speed violation icon 503 indicating that the speed violation has been detected, and that applications have been disabled. In some examples, the user device 112A, 112B may further display a list of the applications displayed, as illustrated by application list icon 505. For instance, application list icon may indicate that a plurality of applications, such as a first application, second application, and a last application, have been disabled (i.e., due to the detected speed violation). As described herein, in some examples, user device 112A, 112B may send an alert, such as a speed alert, to a guardian device 120A, 120B. The alert may include an indication of the speed violation and/or a list of disabled applications based on, for example, the initial setup process. The alert may cause an application of the guardian device 120A, 120B, to display speed violation icon 503 and, in some examples, application list icon 505.

FIG. 5B illustrates additional graphical user interfaces that may be displayed by user devices 112A, 112B and/or guardian devices 120A, 120B on display 500. As illustrated, an outside area speed detection icon 507 indicates that a user device 112A, 112B has detected a speed violation outside of a predetermined area (e.g., outside of geographical area 113A, 113B), as described herein. An inside area speed detection icon 509 indicates that a user device 112A, 112B has detected a speed violation inside of a predetermined area (e.g., outside of geographical area 113A, 113B), as described herein. Further, outside area alert icon 511 indicates that a user device 112A, 112B has detected that it is outside of a predetermined area (e.g., outside of geographical area 113A, 113B), as described herein. Icons 503, 505, 507, 509, and 511 may be generated by the executable safety application (e.g., safety application 181) described herein.

FIG. 5C illustrates the display 500 displaying a setup icon 550 that may be displayed by a user device 112A, 112B during a setup process (e.g., during initial execution of the safety application instructions 222). In this example, setup icon 550 includes various input fields including credential data input field 552 and speed threshold input field 554. Credential data input field 552 allows a user to enter credential data, such as a password. As described herein, the executed safety application may use the credential data provided into the credential data input field 552 to determine whether to re-enable applications that have been disabled during a detected safety violation. In some examples, user device 112A, 112B stores the credential data provided into the credential data input field 552 in database 116 as credential data 182. The speed threshold input field 554 allows a user to enter a speed at which a speed violation will be detected. For instance, if a user device 112A, 112B determines that it is traveling at or greater than the inputted speed threshold, the user device 112A, 112B may detect a safety violation and disable one or more applications and/or calls, and may generate and transmit an alert 311. The inputted speed threshold may be, for example, 5 mph, 7 mph, 15 mph, 25 mph, 40 mph 55 mph, 65 mph, or any other suitable speed.

Setup icon 550 may also include a geographical area input field 556, a guardian contact information input field 338, and a user contact information field 560. The geographical area input field 556 may identify a geographical location, such as geographical area 113A, 113B. In some instances, the geographical area input field 556 allows a user to turn on geofencing, and select a radius from a detected location. As described herein, the user device 112A, 112B may detect a safety violation when the user device 112A, 112B is at a location outside of the geographical location inputted to the geographical area input field 556. The user device 112A, 112B may disable one or more applications and/or calls, and may generate and transmit an alert 311. The guardian contact information input field 338 may allow for entry of contact information for a guardian, such as a name, e-mail address, and phone number (e.g., phone number for guardian device 120A, 120B). As described herein, upon detection of a safety violation, user device 112A, 112B may disable calls to all numbers except to the one entered into the guardian contact information input field 338. In addition, the user contact information field 560 may allow for entry of contact information for a user of the user device 112A, 112B, such as name, address, e-mail address, and phone number.

FIG. 5D illustrates the display 500 with a credential data request icon 570 that may be displayed when user device 112A, 112B detects an attempt to disable (e.g., remove, delete, uninstall) the executed safety application. In some instances, user device 112A, 112B may display the credential data request icon 570 when the deletion attempt is detected. In some instances, user device 112A, 112B may transmit a password request (e.g., password request 417) to, for instance, guardian device 120A, 120B when the deletion attempt is detected. The password request may cause the guardian device 120A, 120B to display the credential data request icon 570 to allow, for example, the guardian to enter credential data. The guardian device 120A, 120B may transmit the inputted credential data (e.g., password 421) back to the user device 112A, 112B. As described herein, the user device 112A, 112B may delete the executed safety application when the received credential data (e.g., entered via credential data request icon 570) matches the originally stored credential data (e.g., credential data inputted into the credential data input field 552 during the setup process of the executed safety application).

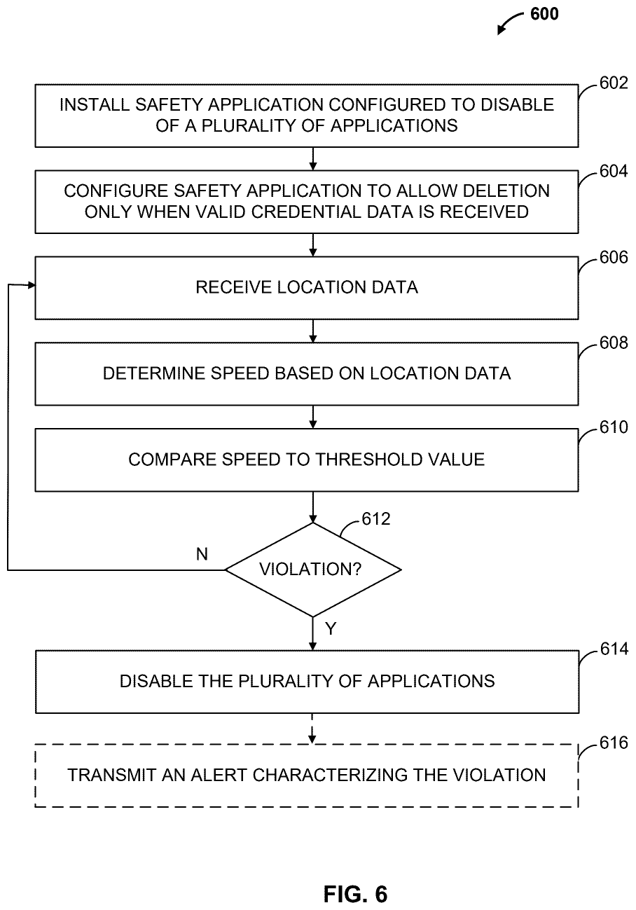

FIG. 6 illustrates a flowchart of an example method 600 to disable mobile applications based on detected safety violations. The method 600 may be carried out by a computing device such as, for example, user device 112A, 112B.

Beginning at block 602, a computing device installs a safety application configured to disable a plurality of applications. For instance, as described herein, user device 112A may download the safety application 181 from database 116, and install the executable safety application within a memory device (e.g., as safety application instructions 222 within instruction memory 207). At block 604, the computing device configures the safety application to allow its deletion only when valid credential data is received. For instance, user device 112A may generate the lock request signal 323 to cause an operating system of the computing device to disallow deletion (e.g., uninstall attempts) of the safety application.

Proceeding to block 606, location data is received. For instance, the user device 112A may receive GPS data via GPS device 206, or cell tower data via transceiver 204. At block 608, the computing device determines a speed based on the location data. For example, and as described herein, the user device 112A may receive location data over a temporal interval (e.g., for at least two points times), and may determine a speed of the user device 112A based on the location data received over the temporal interval.

At block 610, the computing device compares the determined speed to a threshold value, and at block 612, the computing device determines whether a violation has occurred based on the comparison. For instance, as described herein user device 112A may compare speed data 305 with speed threshold 321 to determine whether a speed violation has occurred. If no speed violation has occurred (e.g., the determined speed is less than the threshold value), the method proceeds back to block 606 to receive additional location data. If, however, a speed violation has occurred (e.g., the determined speed is the same as or greater than the threshold value), the method proceeds to block 614.

At block 614, the computing device performs operations to disable the plurality of applications. For example, user device 112A may “lock the screen” thereby preventing any applications from being accessed. In some examples, the user device 112A may disable only applications that have been preselected, e.g., during a setup process of the safety application. In other examples, the user device 112A may disable all applications and all outgoing calls, except calls to a preconfigured number (e.g., the phone number of the guardian device 120A). In some examples, the user device 112A may only disable social media applications and texting applications. The disabling of other types of applications is also contemplated herein.

In some examples, the computing device, at block 616, transmits an alert characterizing the violation. For example, and as described herein, user device 112A may transmit an alert 311 to guardian device 120A, where the alert characterizes the speed violation.

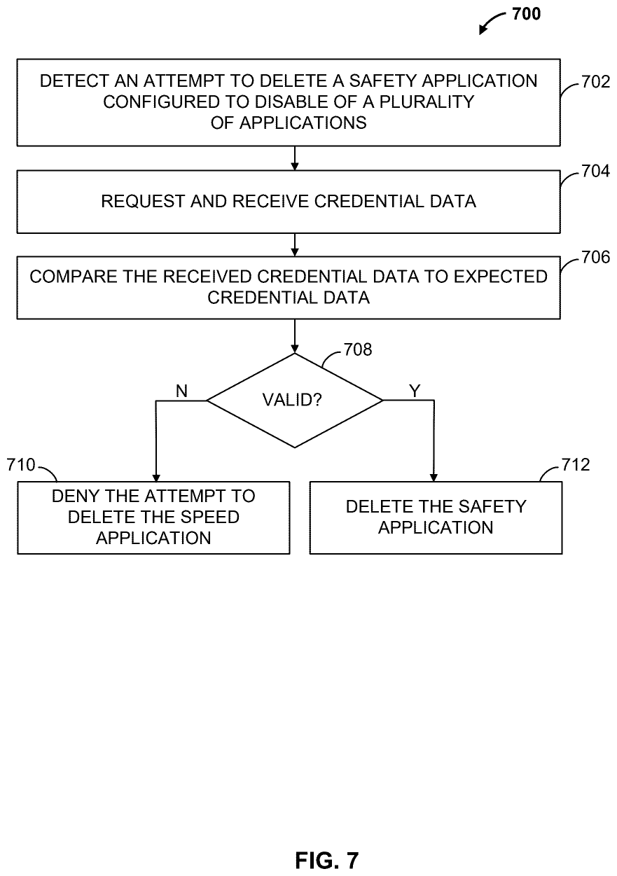

FIG. 7 illustrates a flowchart of an example method 700 to delete a safety application. The method 700 may be carried out by a computing device such as, for example, user device 112A, 112B.

Beginning at block 702, a computing device detects an attempt to delete (e.g., uninstall) a safety application, where the safety application is configured to disable a plurality of applications. For example, as described herein, user device 112A may detect an attempt by a user to uninstall the safety application instructions 222 (e.g., based on detecting an uninstall request). At block 704, the computing device requests and, in response to the request, receives credential data. For example, as described herein, the user device 112A may generate and display a user interface with an input field for a password, and receive the credential data via the input field. In other examples, the user device 112A transmits a password request 417 to the guardian device 120A, and receives, in response, credential data, such as password 421.

Further, at block 706, the received credential data is compared to expected credential data. For instance, user device 112A may compare received credential data to credential data 345. Based on the comparison, at block 708, a determination is made as to whether the received credential data is valid (e.g., if the received credential data is the same as the expected credential data). If the inputted credential data is not valid, the method proceeds to block 710 where the attempt to delete the safety application is denied. If, however, the inputted credential data is valid, the method proceeds to block 712 where the safety application is deleted (e.g., uninstalled from user device 112A).

As described herein, in some examples, a computing device, such as user device 112A, 112B, includes a memory storing instructions for a safety application (e.g., instruction memory 207 storing safety application instructions 222), and at least one processor (e.g., processor 201) communicatively coupled to the memory. The at least one processor is configured to execute the safety application instructions to, among other things, receive location data characterizing a location of the computing device. The at least one processor is also configured to execute the safety application instructions to, based on the location data, generate speed data characterizing a speed of the computing device. Based on the speed data, the at least one processor is configured to execute the safety application instructions to disable at least one executable application of the computing device. The at least one processor is also configured to execute the safety application instructions to detect a request to delete the safety application. Based on the detected request, the at least one processor is configured to execute the safety application instructions to generate a request for credential data.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A computing device comprising:
a memory device storing instructions for a safety application; and
at least one processor communicatively coupled to the memory device and configured to execute the instructions to:
receive location data characterizing a location of the computing device;
based on the location data, generate speed data characterizing a speed of the computing device;
based on the speed data, disable at least one executable application of the computing device;
detect a request to disable the safety application; and
based on the detected request, generate a request for credential data.

2. The computing device of claim 1, wherein the at least one processor is configured to execute the instructions to:
receive the credential data in response to the request;
compare the credential data to expected credential data; and
based on the comparison, determine whether to disable the safety application.

3. The computing device of claim 2, wherein the at least one processor is configured to execute the instructions to:
determine, based on the comparison, that the credential data does not match the expected credential data; and
based on the determination, deny the request to disable the safety application.

4. The computing device of claim 2, wherein the at least one processor is configured to execute the instructions to:
determine, based on the comparison, that the credential data does match the expected credential data; and
based on the determination, disable the safety application.

5. The computing device of claim 4, wherein, to disable the safety application, the at least one processor is configured to execute the instructions to uninstall the safety application.

6. The computing device of claim 1, wherein the at least one executable application of the computing device comprises at least one of a social media application or a texting application.

7. The computing device of claim 1 comprising a display, wherein the generated request comprises a graphical user interface, and wherein the at least one processor is configured to execute the instructions to transmit the graphical user interface to the display.

8. The computing device of claim 7, wherein the graphical user interface includes an input field for inputting the credential data.

9. The computing device of claim 8, wherein the at least one processor is configured to execute the instructions to receive the credential data from the input field.

10. The computing device of claim 1, wherein the at least one processor is configured to execute the instructions to transmit the request to a second computing device, wherein the request causes the second computing device to display a graphical user interface that includes an input field for inputting the credential data.

11. The computing device of claim 10, wherein the at least one processor is configured to execute the instructions to receive the credential data from the second computing device.

12. The computing device of claim 1, wherein the at least one processor is configured to execute the instructions to:
determine, based on the location data, that the computing device is outside a predetermined range; and
based on the determination, disable the at least one executable application of the computing device.

13. The computing device of claim 1, wherein the at least one processor is configured to execute the instructions to:
based on the speed data, determine that the speed is above a speed threshold; and
based on the determination, generate and transmit an alert to a second computing device.

14. The computing device of claim 1, wherein the at least one executable application of the computing device comprises all messaging and texting capable applications.

15. A method by at least one processor for executing a safety application, the method comprising:
receiving location data characterizing a location of a computing device;
based on the location data, generating speed data characterizing a speed of the computing device;
based on the speed data, disabling at least one executable application of the computing device;
detecting a request to delete the safety application; and
based on the detected request, generating a request for credential data.

16. The method of claim 15 further comprising:
receive the credential data in response to the request;
compare the credential data to expected credential data; and
based on the comparison, determine whether to disable the safety application.

17. The method of claim 16 further comprising:
determine, based on the comparison, that the credential data does not match the expected credential data; and
based on the determination, deny the request to disable the safety application.

18. The method of claim 16 further comprising:
determine, based on the comparison, that the credential data does match the expected credential data; and
based on the determination, disable the safety application.

19. The method of claim 18 wherein, to disable the safety application, the method comprises uninstalling the safety application.

20. A non-transitory computer readable medium having instructions stored thereon for a safety application, wherein the instructions, when executed by at least one processor, cause a device to perform operations comprising:
receiving location data characterizing a location of a computing device;
based on the location data, generating speed data characterizing a speed of the computing device;
based on the speed data, disabling at least one executable application of the computing device;
detecting a request to delete the safety application; and
based on the detected request, generating a request for credential data.
